(19) United States
(12) Patent Application Publication
(10) Pub. No.: US 2017/0282950 A1
(43) Pub. Date: Oct. 5, 2017

(54) Collapsible Agile Refreshment Trolley (CART)

(71) Applicant: Ravish Patwardhan, New York City, NY (US)

(72) Inventor: Ravish Patwardhan, New York City, NY (US)

(21) Appl. No.: 15/479,274

(22) Filed: Apr. 4, 2017

Related U.S. Application Data
(60) Provisional application No. 62/318,205, filed on Apr. 4, 2016.

(51) Int. Cl. B62B 3/02; B62B 5/04; B62B 3/00

(52) U.S. Cl. CPC B62B 3/02; B62B 3/005; B62B 5/04

(57) ABSTRACT

The present invention relates generally to a collapsible agile refreshment trolley (CART) that is able to expand and collapse either manually or automatically, to allow passageway of customers in the aisles (e.g. in an airplane, train, ship, bus, or other instance where a narrow region is present and should be circumvented, such as a passenger traveling to a restroom). The CART should be able to be reduced and expanded to allow passageway for emergency (e.g. attending to person having a medical condition after service has begun on the airplane), urgency (e.g. for a passenger in the front of the coach section to go the restroom past the service cart after the service has already begun), or other reasons (e.g. two carts, a drink cart and a food cart, need to pass each other in a narrow passageway, etc.).

### CROSS-REFERENCE TO RELATED APPLICATIONS

This application claims the priority and benefit of U.S. provisional patent application Ser. No. 62/318,205, filed Apr. 4, 2017, entitled “Collapsible Agile Refreshment Trolley (CART)”, the contents of which is hereby incorporated by reference in its entirety.

### FIELD OF THE INVENTION

This invention relates generally to methods and systems for a sideways or front-back collapsing food and/or beverage service cart, using interdigitating compartments which may expand and contract, hence giving a wide platform for serving items but collapsing with base stabilization. More particularly, this invention relates to a sideways or front-back collapsing food and/or beverage service cart for use on a passenger airliner, further particularly to allow passage of a passenger past the cart in the aisle (for example, to go to the restroom from the front to the back of the plane in the main cabin, or for emergency crew to rapidly pass the cart to access a passenger in need).

### BACKGROUND OF THE INVENTION

Present service carts in commercial airlines occupy nearly the complete width of the aisle-way, precluding passengers or emergency personnel to attend to the restroom, emergency equipment, or passenger in need, quickly. Due to the narrow width of the aisle way in most airplanes, there is no present method for a person to pass by the cart, once service has begun, and the cart must be rolled toward the entire front or back of the plane to allow passage, sometimes traveling over 30 rows. Service would be interrupted repeatedly, frustrating passengers being served, while a person in need of passing by (e.g. to reach the restroom or emergency personnel needing to get equipment and reverting, passing the cart twice) would find such passage difficult under present conditions.

### SUMMARY OF THE INVENTION

The present invention relates to methods and systems for creation of a collapsible agile line refreshment trolley (or “CART”) that may collapse, such as, for example, by interlocking compartments which may be pushed together, while maintaining stability and not tipping over. The present invention further relates to a design whereby the cart would be reduced in its width, such as, for example, in half, which may be stabilized to ensure it did not tip over when in a contracted position.

In one aspect of the invention, a stabilizing wide base with low profile “feet” and/or base portion that can be easily stepped over and may be separated by a front-back space may allow the cart to be stabilized at all times, whether collapsed or expanded, with or without using the mechanism of a counterweight to avoid tipping over.

In another exemplary embodiment, the compartments (which may include racks, drawers, or other ledges or item-carrying portions) would fit together, such as with corresponding and/or interlocking sections, such that, for example, one end would be the “female end” and one end the “male end” so that when the CART is contracted. This may be desirable as these ledges don't run into each other, but fit in a corresponding end, such as a male-female end, so that the entire cart collapses, such as, for example, to approximately half its expanded size.

In another exemplary embodiment, the corresponding ends may include a locking mechanism, such as one that is hand-operated or power-operated to allow stability in the contracted or expanded position.

In another exemplary embodiment, upon collapsing the CART, the bottom portion would continue to maintain stability, which may or may not be further stabilized by a wheel-locking mechanism (that can be manually or power-based controlled).

The present invention together with the above and other advantages may best be understood from the following detailed description of the embodiments of the invention and as illustrated in the drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 illustrates embodiments of a collapsible and expandable cart of the present invention;

FIG. 1a illustrates front or back swinging open doors of the cart of the present invention;

FIG. 1b illustrates interlocking corresponding sections of the cart which can expand and collapse to reduce the width of the cart;

FIGS. 2, 2a, 2b, 2c illustrate possible scenarios indicating the CART in the open position when service is ongoing—in a swinging-door description (2a), interlocking compartment description (2), simple sideways-drawer type of configuration (2b), or front/back drawers (2c);

FIG. 3 illustrates the top view of the base portion of the cart with a stepping space for a person and the larger width for stability of the cart;

FIGS. 4 and 4a illustrate an embodiment of a cart with a stabilizing extension, drawers and brake/release levers; and

FIG. 5 illustrates an example of a cart in a commercial aircraft which accommodates the passage of people around the cart.

### DETAILED DESCRIPTION OF THE INVENTION

The detailed description set forth below is intended as a description of the presently exemplified methods, devices and compositions provided in accordance with aspects of the present invention, and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention relates to methods and systems for this CART, which may be applicable in airplanes, trains, ships, other moving vehicles, or other scenarios where such collapsing reduction in profile is beneficial.

Typically, once service has begun on an airplane (or train, ship, or other scenario where a narrow aisle must be traversed, precluding any room for a person to pass past the service cart), the wide profile of the cart severely limits passing by of a person in urgent or emergent cases (such as reaching a restroom, emergency equipment such as a defibrillator, or reaching a passenger in need, for example).

A collapsing feature of the cart is needed for immediate collapse to allow passage of key personnel, with ability to resume expansion so that service can be continued in a practical manner.

When collapsed, the cart should not become destabilized and tip over, particularly, for example, in cases where in an airplane turbulence may be experienced; hence, a stabilizing set of “feet with base connecting to the body unilaterally” (for example, on the opposite side vs. where a person is to pass the cart) with “feet” then easily being able to be walked over to pass the cart) is needed; this can be accomplished by slightly tilting the body of the cart so that the center of gravity is brought closer to the middle rather than unilaterally where the base connects to the body; an additional locking mechanism of the wheels may help with stabilization (e.g. with foot controls).

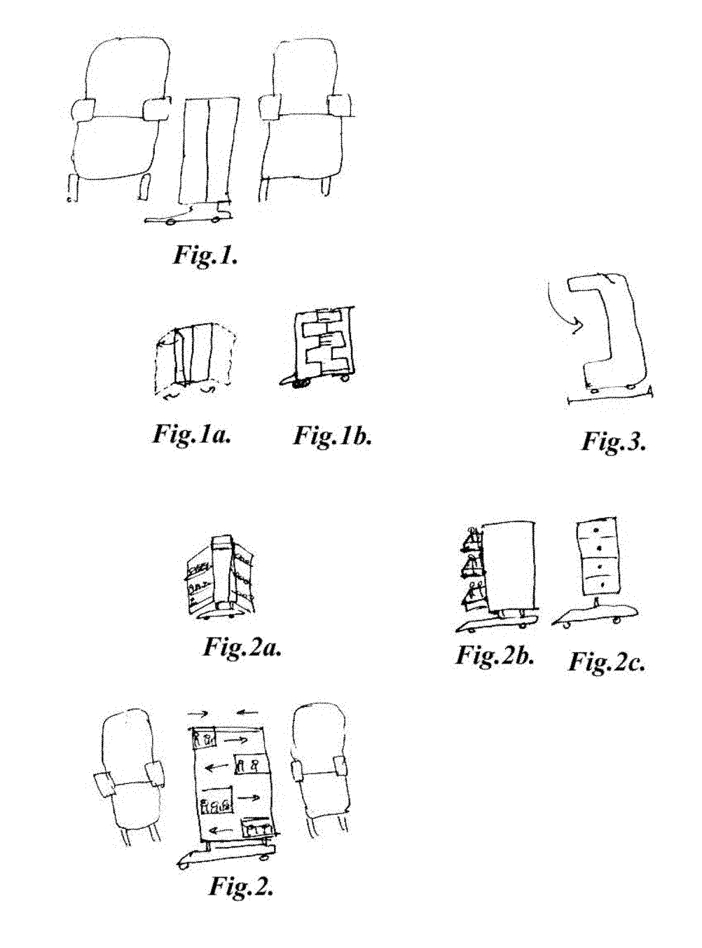

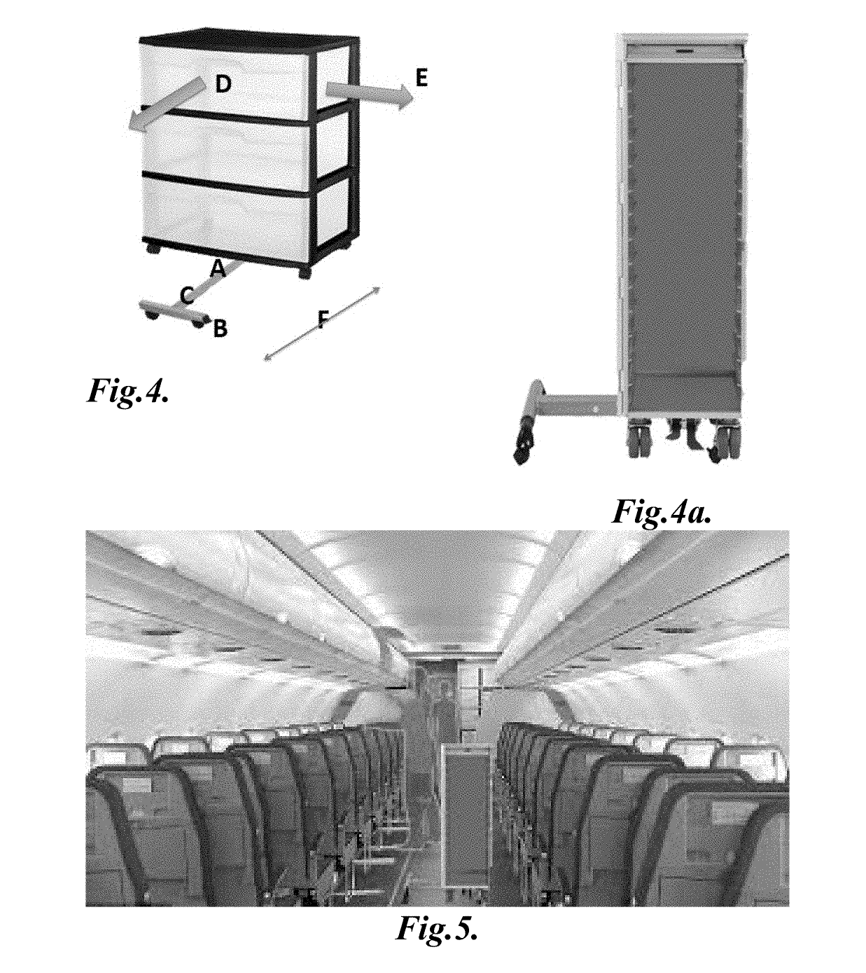

FIG. 1 shows an embodiment of a cart which occupies approximately half of the width of an aisleway between seats, such as in an aircraft or other vehicle. In some embodiments, the cart may include a stabilizing extension from its base which may aid in preventing tip-over. The cart may further include doors or compartments which may swing open, such as in FIGS. 1a and 2a for the front or back ends of the cart, interlocking corresponding sections which may expand and collapse the change the width of the cart as illustrated in FIGS. 1b and 2, or drawers such as illustrated in FIGS. 2b, 2c and 4.

In general, the reduced width of the cart may be utilized to allow people or objects to pass by the cart more easily, as opposed to carts which may take up almost all of the width of the aisle. In some embodiments, the stabilizing extension from the base may be shaped to provide a stepping zone, as shown in the top view of FIG. 3 of the base portion of the cart with a stepping space for a person and the larger width for stability of the cart. In other embodiments, the stabilizing extension may also be configured as a stepping platform for people to be able to stand or step on it as they pass by the cart.

FIG. 4 shows an embodiment of the cart with drawers and a stabilizing extension. As illustrated, the cart in the position with wheeled base extended with center of gravity “A” which is a weighted joint, that when retracted into the cart (for storage) maintains the center of gravity in the center of the width of the cart (whether extended or retracted); “B” shows the wheels on base allowing maneuvering of cart down aisles, and “C” represents the area which can be stepped over by passengers or crew members traversing the narrow aisleways of the airplane (or train or other area); “D” depicts the direction of removal of drawers, tray tables, etc., with alternate depiction being from direction “E”; whereas “F” depicts the width of the available aisle, wherein the cart only occupies about half of what a conventional cart may occupy. FIG. 4a further illustrates the front end of the cart with brake and release levers illustrated for controlling the motion of the cart, such as to prevent the cart rolling uncontrolled during vehicle movement or turbulence.

### EXAMPLE OF “CART” USAGE

The flight attendants of a 777 airliner have just begun service in the main (non-first-class and non-business-class) cabin; about one-third of the way down the aisle, a passenger from the front of the main cabin must reach the restroom with her toddler, hence threatening to interrupt the service to passengers with the only solution being to roll the cart down all the way two-thirds of the aisle to the aft of the plane, since main cabin passengers are not allowed to use first class restrooms. An alternate scenario would be to collapse the cart, allow the toddler and his mother to pass to the restroom, and then expand the cart, continuing service with only a few seconds of interruption.

Similarly, emergency personnel needing to access a passenger having a heart attack, needing to access a defibrillator, and then again access the passenger (while in the inopportune time of being in the middle of service, with the airline cart obstructing the passageways); though service would be purposefully interrupted for such an emergency and the cart moved, this could take time and valuable seconds where life-saving measures could prevail vs. not; a CART-like apparatus would preclude such impositions.

FIG. 5 illustrates an example of the cart in use in a commercial airliner and taking up approximately half the width of the aisle, allowing passengers or other people to pass by to, for example, reach a restroom, return to a seat, allow crew or other personnel to move about or to attend to emergencies or other service needs.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

1. A service cart for a vehicle comprising:
a storage portion which is configured to occupy approximately half of the width of an aisle of a vehicle, said storage portion having at least compartment;
a base portion supporting said storage portion, said base portion having wheels adapted to move said service cart in a vehicle;
a stabilizing extension configured to reversibly extend and contract into said base portion, said stabilizing extension configured to prevent tipping over of said service cart and providing means for permitting a person to step past said service cart when said stabilizing extension is extended.

2. The service cart of claim 1, wherein said at least one compartment comprises a drawer.

3. The service cart of claim 1, wherein said at least one compartment comprises a swinging door compartment.

4. The service cart of claim 1, wherein said at least one compartment comprises an interlocking set of storage features for reversibly expanding the width of said service cart.

5. The service cart of claim 1, wherein said means for permitting a person to step past said service cart when said stabilizing extension is extended comprises stepping zones where a person may step onto the ground.

6. The service cart of claim 1, wherein said means for permitting a person to step past said service cart when said stabilizing extension is extended comprises a stepping platform for a person to stand or step on.

7. The service cart of claim 1, further comprising a brake mechanism for arresting motion of said wheels.

8. The service cart of claim 1, wherein said vehicle is selected from the group consisting of a commercial airliner, a passenger train and a passenger bus.
